(19) United States
(12) Patent Application Publication
(10) Pub. No.: US 2023/0297887 A1
(43) Pub. Date: Sep. 21, 2023

(54) SYSTEMS AND METHODS FOR GENERATING AUTOMATIC TRAINING SUGGESTIONS

(71) Applicant: ADA Support Inc., Toronto (CA)

(72) Inventors: Armand Silviu Gurgu, Toronto (CA); Christos Melidis, Thessaloniki (GR); Gordon Gibson, Toronto (CA); Adam Sils, Kelowna (CA); Ashley George, Bedford (CA); Nima Tabatabaei, Toronto (CA); Aman Bhatia, Coquitlam (CA)

(21) Appl. No.: 18/082,394

(22) Filed: Dec. 15, 2022

Related U.S. Application Data
(60) Provisional application No. 63/320,041, filed on Mar. 15, 2022.

(51) Int. Cl. G06N 20/00

(52) U.S. Cl. CPC G06N 20/00

(57) ABSTRACT

Systems and methods for generating training questions are disclosed. The method includes identifying a structure for generating an input; formulating the input according to the structure; providing the input to a first machine learning model; receiving an output from the first machine learning model based on the input; and training a second machine learning model based on the output. The first machine learning model may be a pre-trained generative language model.

### CROSS-REFERENCE TO RELATED APPLICATION(S)

The present application claims the benefit of U.S. Provisional Patent Application No. 63/320,041 filed in the United States Patent and Trademark Office on Mar. 15, 2022, the content of which is incorporated herein by reference.

### FIELD

One or more aspects of embodiments according to the present disclosure relate to natural language processing, and more particularly to automatically generating training questions for training a machine learning model.

### BACKGROUND

A business may employ automated systems and representatives of the business to process transactions and/or service the needs of its customers. Utilizing human agents to interact with the customers may sometime result in delays if the agents are not available to service the customers. Utilizing human agents may also be costly for the business due to increased overhead and increased complexity to the business operation.

One mechanism for handling customer needs in a more efficient manner may be to employ a question answering system (hereinafter referred to as a chatbot or chatbot system). Using chatbots, however, may be challenging. For example, if a chatbot has not been trained to recognize a particular user question, the chatbot may not be effective in responding to the question, and may be unable to handle the customer needs.

The above information disclosed in this Background section is only for enhancement of understanding of the background of the present disclosure, and therefore, it may contain information that does not form prior art.

### SUMMARY

One or more embodiments of the present disclosure are directed to a method for generating training questions. The method includes identifying a structure for generating an input; formulating the input according to the structure; providing the input to a first machine learning model; receiving an output from the first machine learning model based on the input; and training a second machine learning model based on the output.

According to some embodiments, the structure is a prompt structure for generating a prompt, wherein the prompt identifies a task for generating the output.

According to some embodiments, the output is a question generated based on the prompt.

According to some embodiments, the prompt structure includes preset wording and a placeholder for entering at least an answer title or an answer content for generating the question.

According to some embodiments, the identifying of the structure includes identifying the structure based on a predicted success of the first machine learning model in generating the output.

According to some embodiments, the first machine learning model is a generative language model.

According to some embodiments, the method further comprises filtering the output based on a predicted characteristic of the output, wherein the training of the second machine learning model is based on the filtered output.

According to some embodiments, the first machine learning model and the second machine learning model are different models.

According to some embodiments, the method further comprises selecting a hyperparameter for the first machine learning model for optimizing performance of the first machine learning model.

According to some embodiments, the method further includes generating a prompt according to the structure; providing the prompt to the first machine learning model; receiving a first training question from the first machine learning model based on the prompt; computing a metric for the first training question; and altering a parameter of the first machine learning model based on the metric.

According to some embodiments, the computing of the metric includes receiving feedback about the first training question; and computing the metric based on the feedback.

According to some embodiments, the method further comprises including the first training question in a second prompt for generating a second training question.

One or more embodiments of the present invention are directed to a system for generating training questions. The system includes a processor and a memory. The memory includes instructions that, when executed by the processor, cause the processor to: identify a structure for generating an input; formulate the input according to the structure; provide the input to a first machine learning model; receive an output from the first machine learning model based on the input; and train a second machine learning model based on the output.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a block diagram of a network environment including a chatbot system, a chatbot builder, a knowledge base, and an end user device, according to one or more embodiments;

FIG. 2 is a block diagram of the chatbot system of FIG. 1 according to one or more embodiments;

FIG. 3 is a block diagram of a training system according to one or more embodiments;

FIG. 4 is a flow diagram of a process for training an inference model based on automatically generated training questions according to one or more embodiments;

FIG. 5 depicts a screen shot of an exemplary graphical user interface provided by a user portal for generating suggestions of training questions according to one or more embodiments; and

FIG. 6 is a flow diagram of a process for evaluating suggested training questions according to one or more embodiments

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

A business may employ an automated answering system, a chat bot, a chat robot, a chatterbot, a dialog system, a conversational agent, and/or the like (collectively referred to as a chatbot) to interact with customers. Customers may use natural language to pose questions to the chatbot, and the chatbot may provide answers that are aimed to be responsive to the questions. The quality/responsiveness of the answers may depend on the training received by the chatbot. If the chatbot's training is insufficient to properly answer a user's question, it may lead to prolonged engagement with the chatbot, resulting in increased use of hardware and software resources, and decreased customer satisfaction.

Training chatbots, however, can be an arduous task. When training is performed by a non-technical customer support team member (hereinafter referred to as a chatbot administrator), the training of a chatbot may be even more difficult. Accordingly, there is a need for systems and methods to aid the chatbot administrators to train chatbots. As a person of skill in the art should appreciate, efficient and effective training of chatbots result in more efficient and effective interactions with users of the chatbot.

Over the past few years, advancements in hardware capabilities have allowed the training of large language models that may be generalized for downstream tasks. Many of these tasks may achieve state-of-the-art performance with only a few task-specific training examples. This has led to the emergence of “in-context learning” where instructions to downstream tasks are stated in natural language (referred to as a prompt), and solved by feeding the prompt to the language model as input for (also referred to as “conditioning” on the prompt).

More specifically, for in-context learning of a given task, the language model may receive as an input prompt, a description of the task, an optional number of labeled examples demonstrating the task, and a final test input that the model is expected to complete itself. The examples of the task provided to the model may be pairs of queries and answers formatted in some consistent way. The completion of the final test input by the language model may be by conditioning on the prompt.

An in-context learning that uses a zero number of labeled examples for the task may be referred to as “zero-shot learning.” Zero-shot learning of a task that determines a tweet's sentiment may use the following input and output:
**Input (Prompt)**
Decide whether a Tweet's sentiment is positive, neutral, or negative.
Tweet: “I loved the new Batman movie!”
Sentiment:
**Generated Output:**
Positive

In-context learning may be improved by introducing a few examples of the task to allow for “few-shot learning.” Few-shot learning of the above task that determines a tweet's sentiment may use the following input and output:
**Input (Prompt)**
Decide whether a Tweet's sentiment is positive, neutral, or negative.
Tweet: “I loved the new Batman movie!”
Sentiment: Positive
Tweet: “I didn't like the new Batman movie at all!”
Sentiment: Negative
Tweet: “I am walking in the park!”
Sentiment: Neutral
Tweet: “The food was really not good!”
Sentiment:
**Generated Output:**
Negative

It should be appreciated that the performance of the language model for accurately making predictions that fulfill a particular task may depend on the types of prompts provided to the language model, and/or the labeled examples included in the prompts. For example, by selecting the appropriate prompts, an administrator may be able to manipulate a model's behavior so that the language model may be used to predict the desired output even without any task-specific training.

In some embodiments, the language model used for in-context learning is a generative language model. The task given to the generative language model may be to generate synthetic training data using the input prompt. The use of a generative language model in a traditional manner, however, may not be without limitations. For example, because a generative language model is a black box solution, there may be a general lack of interpretability of the outputs that it produces. In addition, the general difficulty to control the generation process may require careful prompt engineering and experimentation. Furthermore, because the generative language model is probabilistic by nature, the generated output may contain sensitive content or content that may not reflect the real world.

In general terms, embodiments of the present disclosure are directed to systems and methods for automatically generating suggestions of training questions or queries using a generative language model. The term “questions” or “queries” will be used interchangeably herein. The generated training questions may be used by a chatbot administrator to train a chatbot to provide answers to user queries. The trained chatbot may employ a machine learning model that may be separate from, or the same as, the generative language model.

In one embodiment, the generative language model is provided a prompt to generate one or more training questions. The prompt may have a structure that has been predicted to be successful in generating meaningful training questions. In some embodiments, the prompt is generated based on content that is relevant to the enterprise that is to use the chatbot. In this regard, the prompt may include a topic of discussion typical for the enterprise, text describing a context of the discussion, and describe the task as generating a question about the topic of discussion. The language model may engage in zero-shot or few-shot in-context learning to fulfill the described task.

In some embodiments, the question that is output by the language model is filtered based on a predicted characteristic of the question. For example, a question that is predicted to contain unsafe or sensitive content may be filtered. In other examples, a question that is likely to be semantically irrelevant to the topic and/or content of the discussion provided in the prompt may also be filtered.

In some embodiments, a model evaluation system evaluates the capabilities of the language model in generating meaningful training questions. In this regard, feedback may be received about the generated training questions, and one or more metrics computed based on the received feedback. The feedback may be provided, for example, by the chatbot administrator. One or more aspects of the language model may be modified based on the computed metrics. For example, one or more hyperparameters of the language model, and/or the prompt structure may be altered based on the computed metrics.

In some embodiments, a generated training question is funneled back into the prompt to simulate few-shot learning. The training question that is selected for the few-shot learning may be one for which the chatbot administrator provides positive feedback.

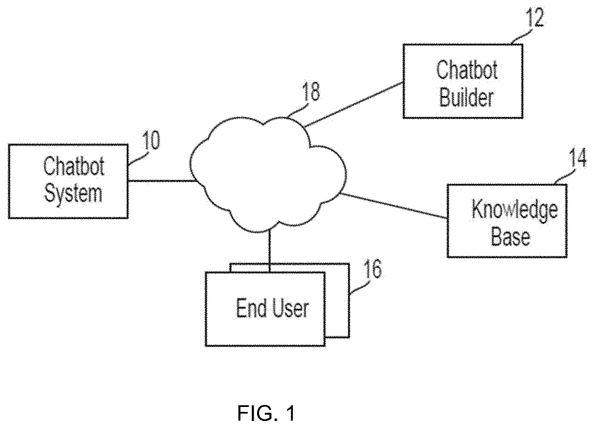

FIG. 1 is a block diagram of a network environment including a chatbot system 10, a chatbot builder 12, a knowledge base 14, and an end user device 16, according to one or more embodiments. The chatbot system 10, chatbot builder 12, knowledge base 14, and end user device 16 may be coupled to one another over a data communications network 16. The data communications network 16 may a local area network, private wide area network, and/or public Internet.

In some embodiments, the chatbot system 10 may include a processor and a memory, where the memory includes instructions that cause the processor to provide the functionality of the chatbot system 10 described herein. In some embodiments, the chatbot system 10 is configured to handle interactions with the end user device 16. The chatbot system 10 may be configured to handle interactions on behalf of a particular business or enterprise, or on behalf of multiple businesses or enterprises. For example, a separate instance of a chatbot system 10 may be provided for each separate enterprise for handling interactions of that enterprise.

The end user device 16 may be a desktop, laptop, and/or any other computing device conventional in the art. A customer, potential customer, or other end user (collectively referenced as an end user) desiring to receive services from the enterprise may initiate communications to the chatbot system 10 using the end user device 16. For example, the end user may formulate a query, and transmit the query to the chatbot system 10 as a chat message, text message, social media message, and/or the like. The chatbot system 10 may process the query and determine a user intent. One or more machine learning models may be invoked for predicting the user intent Once the intent is determined, the chatbot may output an answer in response to the query. The one or more machine learning models, and software and hardware for interfacing with the end user devices 16, may generally be referred to as a chatbot.

In one embodiment, the chatbot builder 12 may include a computing system that is used by a chatbot administrator to configure, train, and/or maintain, for a particular enterprise, one or more machine learning models (also referred to as inference models) of the chatbot system 10. The computing system may be a desktop computer, laptop computer, network server, mobile device, embedded computer, and/or the like.

In some embodiments, the chatbot system 10 provides recommendations of training data that may be used by the chatbot builder 12 to train the inference models used by the chatbot to respond to user queries. The training data may include question and answer pairs that may be generated based on information in the knowledge base 14. The knowledge base 14 may include any source of information for the particular enterprise that is serviced by the chatbot system 10. For example, the knowledge base 14 may include the enterprise's website, database, social media sites, and/or any other online repository of source data for the enterprise. The automatic recommendation of question and answer pairs that may be used as the training data may help expedite the training of the chatbot, which may otherwise be a time-consuming process.

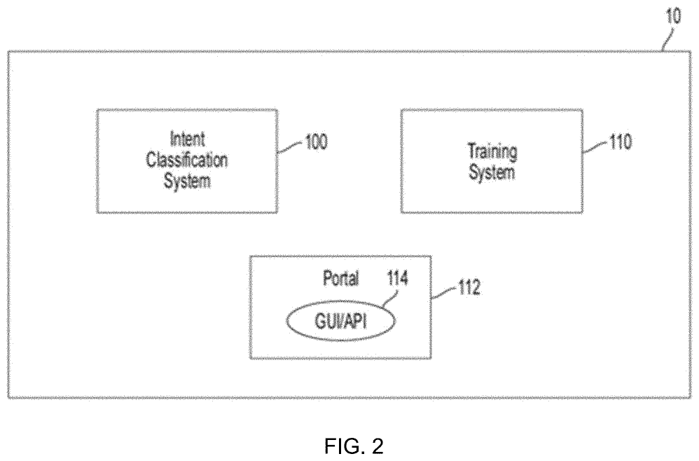

FIG. 2 is a block diagram of the chatbot system 10 according to one or more embodiments. The chatbot system 10 may include, without limitation, an intent classification system 100, training system 110, and administrator portal 112. Although the chatbot system 10, intent classification system 100, training system 110, and the administrator portal 112 are depicted in FIG. 2 as separate components, a person of skill in the art should recognize that these components 10, 100, 110, 112, may be combined into a single component, or one or more of the components may be further subdivided into additional sub-components as will be appreciated by a person of skill in the art.

The intent classification system 100 may include one or more machine learning models (also referred to as inference models) that are trained to identify a user intent based on a user query. For example, the intent classification system 100 may receive a query such as “What is my order status,” “I need to make a payment,” or “Can I get a refund on my item,” and output a predicted intent for the query, such as, for example, “order status,” “make payment,” or “get refund.” A response or answer may be output based on the classified intent.

The inference models used by the intent classification system 100 may include, for example, deep neural networks, shallow neural networks, and the like. The neural network(s) may have an input layer, one or more hidden layers, and an output layer. One or more of the neural networks may generate one or more embeddings (also referred to as features) from the user query. The embeddings may be word and/or sentence embeddings that represent one or more words of the user query as numerical vectors that encode the semantic meaning of the query. In this regard, the embeddings may also be referred to as semantic representations. In one example, the embeddings may be represented as a vector including values representing various characteristics of the word(s) in the query, such as, for example, whether the word(s) is a noun, verb, adverb, adjective, etc., the words that are used before and after each word, and/or the like.

In some embodiments, the embeddings may be generated by a language model such as, for example, a Bidirectional Encoder Representations and Transformers (BERT) model. In some embodiments, the language model may be fine-tuned in a multi-task setting. For example, the model may be fine-tuned by adjusting values of one or more learnable parameters of the language model for a particular task. In some embodiments, a deep neural network that has been fine-tuned based on user queries may be used to generate the embedding vectors, in addition or in lieu of the BERT model.

The training system 110 may be configured to train one or more machine learning models of the intent classification system 100. In some embodiments, some or all components of the training system 110 may be incorporated into the intent classification system 100. The training system 110 may train or retrain (collectively referenced as “train”) the one or more machine learning models using training data. The training may include supervised and/or unsupervised training.

In some embodiments, the training system 110 is configured to automatically recommend training questions to the chatbot builder 12 for training the one or more machine learning models of the intent classification system 100. One or more training questions may be generated based on an input prompt. The prompt may be manually and/or automatically formulated using the source data in the knowledge base 14. In this manner, the generated training questions may be catered to the enterprise's business.

In some embodiments, the training system 110 is configured to evaluate the recommended training question to determine whether the question contains content that should be filtered. For example, a question that is predicted to contain unsafe or sensitive content may be discarded and not used as training data. In some embodiments, the training system 110 is configured to determine whether the recommended training question is semantically relevant to, for example, at least a portion of the prompt. The recommended question may be discarded if the question is predicted to be semantically irrelevant to the prompt.

In some embodiments, the suggested training questions that are not discarded may be used to augment an existing training dataset. The augmented training dataset may be used to train a machine learning model of the intent classification system 100. In some embodiments, the filtered training questions may be used alone for training the machine learning model of the intent classification system 100.

In some embodiments, the chatbot administrator provides feedback on the recommended questions for further tuning the language model and/or prompt structure. For example, the feedback may be approval or disapproval of the recommended questions, or some other indication that the recommended questions are accepted or rejected by the chatbot administrator. The feedback may be provided to the training system 110 via the administrator portal 112. The administrator portal 112 may be a server that serves a GUI or an application programming interface (API) (collectively referenced as GUI) 114 that the chatbot administrator may access through the chatbot builder 12. The access of the portal 112 may be via the Internet using, for example, a web browser or an API.

For example, the GUI may cause display of a recommended training question, and prompt the chatbot administrator to accept or reject the recommended training question. The chatbot administrator's responses may be provided to the training system 110 for modifying one or more aspects of the language model and/or prompts used to generate the recommended training questions.

In some embodiments, the GUI provides a template containing the prompt structure that the chatbot administrator may use to generate prompts for the language model. In some embodiments, the prompt is automatically generated using the prompt structure based on answer content maintained by the client. The answer content may be, for example, answers in a frequently asked portion of the client's website.

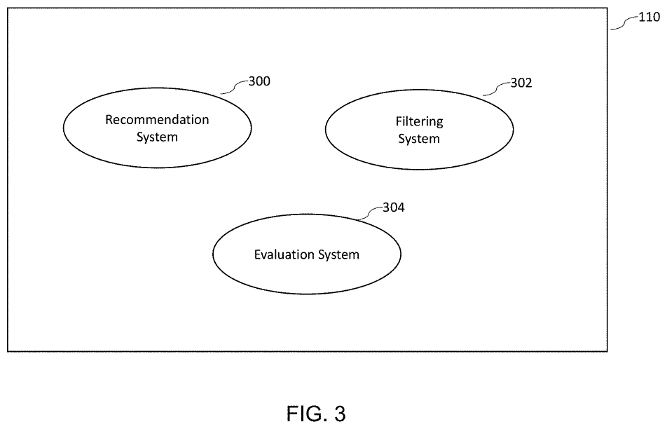

FIG. 3 is a block diagram of the training system 110 according to one or more embodiments. The training system 110 may include, without limitation, a recommendation system 300, filtering system 302, and evaluation system 304. Although the recommendation system 300, filtering system 302, and evaluation system 304 are depicted in FIG. 3 as separate components, a person of skill in the art should recognize that these components 300-304 may be combined into a single component, or one or more of the components may be further subdivided into additional sub-components as will be appreciated by a person of skill in the art.

The recommendation system 300 may be configured to generate a suggested training question based on an input. In some embodiments, the recommendation system 300 includes a machine learning model for generating the suggested training question. The machine learning model may be, for example, a generative language model such as Generative Pre-Trained Transformer 3 (GPT-3), although embodiments are not limited thereto.

In some embodiments, the chatbot administrator invokes the language model (e.g., via the chatbot builder 12 and administrator portal 112) to receive the recommended training questions. In this regard, the chatbot administrator generates a prompt as an input to the language model. The prompt may be formulated according to a prompt structure. The appropriate prompt structure for generating the questions may be identified by the recommendation system 300.

In some embodiments, the recommendation system 300 provides a template that follows the identified prompt structure for use by the chatbot administrator to generate an input prompt. The prompt structure may include preset wording and a placeholder for data to be entered by the chatbot administrator. In some embodiments, the placeholder is identified via brackets, although embodiments are not limited thereto. For example, the placeholder data to be input by the chatbot administrator may be an answer title, a textual answer content, and optional N number of training questions. For a zero-shot generation process, the prompt template may have the following prompt structure:
The topic of discussion is [answer title].
The context of the discussion is [answer content].
Question about [answer title]:

In one embodiment, the above prompt template is extended to incorporate one or more training questions for few-shot learning, where the one or more training questions may be deemed to be examples of the task described in the prompt. The training questions may be, for example, questions recommended by the language model that have been validated by the chat administrator. The prompt structure for a few-shot generation process may be as follows:
The topic of discussion is [answer title].
The context of the discussion is [answer content].
Question about [answer title]: [Training Question 1]
. . .
Question about [answer title]: [Training Question N]
Question about [answer title]:

In some embodiments, the recommendation system 300 selects a prompt structure from one or more different prompt structures based on a predicted success in generating a training question. The success may be based on a semantic similarity measure. For example, one prompt structure may use the wording “The item to be discussed is” while another prompt structure may use the wording “The topic of discussion is.” The prompt structure that provides a training question with a higher semantic similarity measure to the input prompt may be selected for use by the recommendation system 300.

In one embodiment, the filtering system 302 evaluates the recommended training question for determining whether all or a portion of the training question should be filtered. In this regard, the filtering system 302 includes a fine-tuned machine learning model that predicts a characteristic of the question. For example, the machine learning model may predict whether the question can be characterized as containing unsafe or sensitive content. If the question is characterized as containing unsafe or sensitive content, the question may be discarded.

In one embodiment, the characteristic determined by the filtering system 302 is semantic and/or lexical similarity of the generated question to the input prompt. In one embodiment, filtering system 302 generates n-grams of the words contained in at least a portion of the prompt (e.g., answer title and/or answer content), and n-grams of the words contained in the generated question. The filtering system 302 may compare the n-grams to determine overlap between the generated question and the prompt. The amount of overlap in the n-grams may be used as an indication of semantic relevance of the generated question to the prompt containing at least a portion of the answer. In addition or in lieu of n-grams, a cosine similarly measure may be used to compute the semantic similarity between the generate question and the prompt.

In some embodiments, lexical similarity may be computed by transforming the generated question and the prompt into vectors, and computing a similarity measure for the vectors. The vectors may be generated using an algorithm such as the Term Frequency-Inverse Document Frequency (TF-IDF) algorithm. The similarity measure may be a cosine similarity measure.

In some embodiments, semantic similarity may be computed by transforming the generated question and the prompt into vectors, and computing a similarity measure between the vectors. The vectors may be generated using a neural network such as BERT. The similarity measure may be a BERTScore, a measure of vector similarity based on BERT.

In one embodiment, the filtering system 302 discards the generated question in response to the lexical and/or semantic relevance being below a threshold.

In some embodiments, the evaluation system 304 evaluates the question generation capabilities of the generative model, and selects a generative model, prompt structure, and/or hyperparameters for generating (e.g., for optimally generating) the question suggestions.

In some embodiments the evaluation system 304 samples (e.g., randomly samples) the knowledge base 14 for answer content, and generates an input prompt based on the answer content. The input prompt may be automatically generated by the evaluation system 304 using a current prompt structure. In some embodiments, the chatbot administrator generates the prompt using the randomly sampled answer content.

In some embodiments, a plurality of answer content is sampled for generating a plurality of prompts. The prompts are provided to the large language model for receiving various question suggestions based on the prompts. In some embodiments, the evaluation system 304 computes one or more metrics for the generated question suggestions. A parameter of the large language model may be altered based on the one or more metrics. For example, a hyperparameter of the language model may be altered. In some embodiments, the alteration may be of the prompt structure. In yet some embodiments, the current large language model may be replaced with a different large language model based on the computed metrics.

In some embodiments, the metrics are computed based on received feedback for the question suggestions. For example, the question suggestions may be presented to the chatbot administrator. The chatbot administrator may be prompted to accept or reject the question suggestion, and label the suggestion accordingly. The chatbot administrator may accept or reject the question suggestion based on relevance of the question suggestion to the answer content.

In some embodiments, the relevance of the question suggestion to the answer content is automatically computed based on semantic similarity of the question suggestion to the answer content. Semantic similarity may be computed by generating one or more vectors for the words in the question suggestion and the words used for the answer content, using an algorithm such as TF-IDF.

In some embodiments, vector embeddings are computed for the question suggestion and the answer content. The embeddings may be word and/or sentence embeddings that represent one or more words of an input (e.g., the question or answer) as numerical vectors that encode the semantic meaning of the input.

In one embodiment, in computing the similarity to the question suggestion to the answer content, the evaluation system 304 computes a cosine similarity distance between the embeddings generated for the question suggestion, and the embeddings generated for the answer content. The question suggestion may be accepted as being semantically relevant if the computed cosine similarity distance is below a threshold. In some embodiments, the evaluation system 304 assigns an appropriate label to the question suggestion as, for example, rejected or accepted, based on the semantic relevance determination.

In some embodiments, the evaluation system 304 uses the received feedback for computing one or more metrics. The computed metrics may include, without limitation, the following:
1. Mean Suggestion Acceptance Rate (MSAR): average ratio of accepted suggestions to generated suggestions.
2. Mean Suggestion Acceptance Value (MSAV): average number of training suggestions accepted per generation.
3. Useful Generation Rate (UGR): average number of generations which have at least one accepted suggestion.

In some embodiments, the evaluation system 304 employs the following formulas for computing the metrics:

$$M S A R = \frac{1}{K} {\sum }_{i = 1}^{K} ( \frac{1}{\vert {S}_{i} \vert} {\sum }_{j = 1}^{\vert {S}_{i} \vert} {1}_{{s}_{i , j} = relevant} ) ∈ [ 0 , 1 ]$$

$$M S A V = \frac{1}{K} {\sum }_{i = 1}^{K} ( {\sum }_{j = 1}^{\vert {S}_{i} \vert} {1}_{{s}_{i , j} = relevant} ) ∈ [ 0 , {mean}_{i} ( \vert {S}_{i} \vert ) ]$$

$$U G R = \frac{1}{K} {\sum }_{i = 1}^{K} {1}_{relevant ∈ {S}_{i}}$$

where Si represents a set of generated suggestions for answer content i, 1 represents the characteristic function, and K represents the number of generated training question suggestions.

Intuitively, an optimal generative model may have the following characteristics: 1) ability to generate high quality suggestions which are mostly accepted by the chatbot administrators; and 2) ability to generate multiple suggestions per API call. High values of UGR and MSAR may correspond to the first characteristic while high values of MSAV may correspond to a second characteristic.

Two exemplary generative models G1 and G2 may be considered to further illustrate the complementary nature of UGR, MSAV and MSAR. In one example, G1 generates two suggestions, and a chatbot administrator accepts both suggestions, while G2 generates five suggestions, and a chatbot administrator accepts all five suggestions. The use of one answer block is assumed for this example without loss of generality.

In the above example, both G1 and G2 have a UGR=MSAR=1.0. However, G1 has MSAV=2 while G2 has MSAV=5. The MSAV metric may be used to get a more fine-grained understanding of different models' performance.

In some embodiments, an aggregate of the one or more metrics computed for a first large language model is compared against an aggregate of the one or more metrics computed for a second large language model. The first language model may be different from the second large language model in terms of type, and/or value of one or more hyperparameters. The prompt structure used to generate a prompt for the first large language model may be the same or different from the prompt structure used to generate a prompt for the second large language model.

In some embodiments, one or more hyperparameters of the model may be controlled for optimizing performance of the model in generating useful and unique training questions. Using GPT-3 as an example, the hyperparameters that may be controlled include, for example, temperature, top-k and top-p. The values of the hyperparameters may control the output tokens (e.g., words) that are selected by a decoding strategy for the question suggestion.

### Temperature

In some embodiments, the temperature hyperparameter is used to control randomness of the generated output.

$$qi = \frac{exp ( \frac{Z i}{T} )}{{Σ}_{j} exp ( \frac{Z j}{T} )}$$

where q is the output (e.g., probability of the token at place i to be selected), z the value of the i-th logit and T the temperature value T∈[0, 1]. The closer the selected temperature is to zero, the “harder” the output of the Softmax will be (having more support to the highest logit), while with higher values the Softmax output will be “softer” (evening out the output values of the Softmax). This results to a token sampling that is almost deterministic for low values and more stochastic the higher the temperature gets.

In some embodiments, higher temperature values are selected when no training questions are present for a given answer for better performance of the language model. In contrast, when training questions are present, the generated suggestions are aimed to be similar to the existing questions. Therefore, lower temperature values are selected when training questions are present as they may lead to better performance. For example, the decrease of the temperature may be proportional to the number of training questions that are used.

### Top-k and Top-p

The decoding strategy in many cases may not include all possible tokens, as the tail of the output distribution may get prohibitively long. In one embodiment, the top-k hyperparameter may be manipulated to control the number of top tokens to use in each decoding step for the question suggestion. According to one embodiment, the top-k value is set to 5.

In one embodiment, the selection of tokens may be based on a decoding strategy that dynamically selects a certain number of tokens based on their values. In this regard, a top-p, Nucleus Sampling, hyperparameter may control the sum of token likelihood that is sampled. For example, if p=15%, only the top tokens whose likelihood adds to 15% are sampled, whether those may be 2, 5, or 3 depending on the values in the particular decoding step. According to one embodiment, the top-p value is set to 0.9.

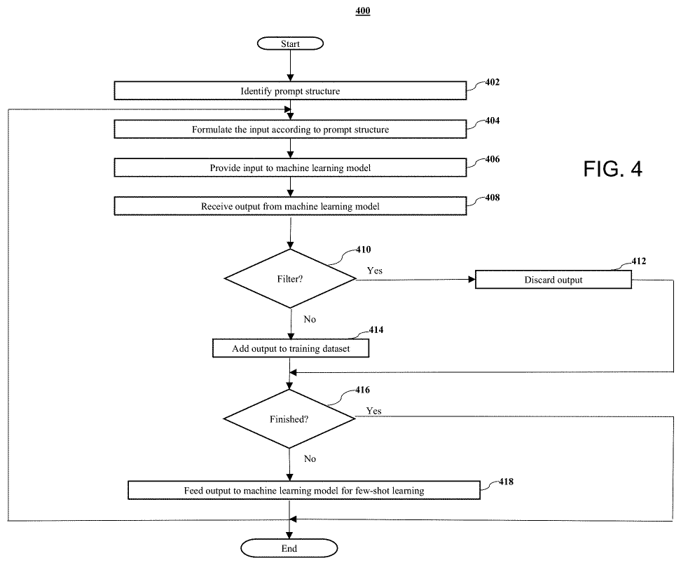

FIG. 4 is a flow diagram of a process 400 for training an inference model based on automatically generated training questions according to one or more embodiments. The process starts, and in act 402, a prompt structure is identified by, for example, the training system 110. The prompt structure may identify a task for a machine learning model for generating an output. The machine learning model may be, for example, a generative language model. In one embodiment, the output is a suggested training question.

The identified prompt structure may include preset wording and one or more placeholders for entering content selected by, for example, the chatbot administrator. The content may be, for example, an answer title and/or an answer content selected from the enterprise's knowledge base 14. The prompt structure may also include placeholders for one or more labeled examples that may be answered by the identified content. In some embodiments, the prompt structure is identified based on a predicted success of the machine learning model in generating an output based on the selected prompt structure.

In act 404, an input to the machine learning model is formulated based on the identified prompt structure. In this regard, the placeholder may be replaced with the content selected by the chatbot administrator, and one or more labeled examples if such examples are provided.

In act 406, the input is provided to the machine learning model. In this regard, the machine learning model may engage in in-context learning where the machine learning model learns how to perform a task by conditioning on the input. In some embodiments, one or more tokens (e.g., words of the suggested question) are selected based on the in-context learning. In this regard, a probability score may be computed for each token within a vocabulary of the model based on training received by the model, and one or more tokens may be selected based on the probability score.

In act 408, an output is generated by the machine learning model. The output may be a suggested question based on the selected tokens.

In act 410, a determination is made as to whether the output is to be filtered based on a predicted characteristic of the output. For example, the filtering system 302 may invoke a separate machine learning model to predict whether the output contains sensitive or unsafe content. The filtering system 302 may filter or discard the output, in act 412, if the output is predicted to contain sensitive or unsafe content.

In some embodiments, the predicted characteristic includes textual similarity of the output to all or a portion of the input (e.g., the answer title and/or answer content). In this regard, the filtering system 302 may compute semantic similarity and/or lexical similarity scores to determine whether the output is textually similar to at least a portion of the input. The output may be filtered in act 412 in response to the similarity measure being below a threshold value.

If the output is not discarded, it is added to a training dataset in act 414. In some embodiments, the output may be validated by the chatbot administrator prior to being added to the training dataset. The training dataset may be used to train a second machine learning model (e.g., the inference model of the intent classification system 100).

In act 416, a determination is made as to whether the generating of question suggestions has ended. In this regard, the training system 110 is configured to generate multiple (e.g., ten) question suggestions per API call by the chatbot builder 12 using a particular prompt.

If the answer is NO, the output is fed to the machine learning model for generating a new output using few-shot learning. In some embodiments, a new prompt is generated in act 404 using the prior output as a labeled example for the new output. In one embodiment, the new output generated by the machine learning model is different from the prior output.

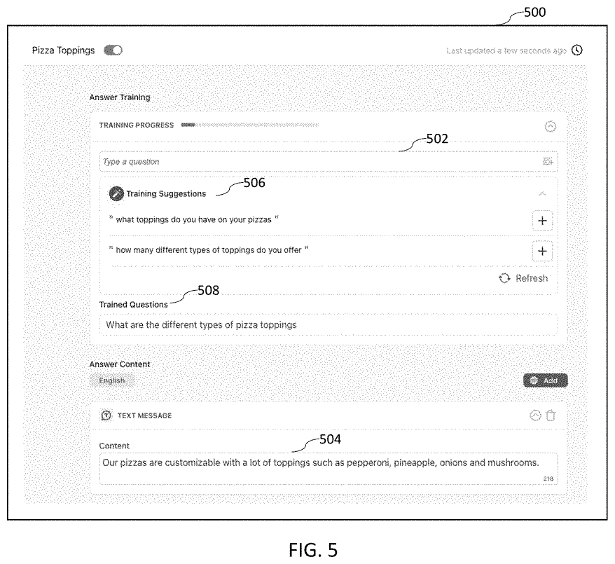

FIG. 5 depicts a screen shot of an exemplary GUI 500 provided by the portal 114 for generating suggestions of training questions according to one or more embodiments. The GUI 500 may include fillable sections that the chatbot administrator may use to generate a prompt. The fillable sections may be determined based on the prompt structure selected by the training system 110. In some embodiments, section 502 may be used to enter the last portion of the prompt (e.g., the text “Question about [answer title]”) that is to be answered by the machine learning model. Section 504 may be used to select the answer content for the question. A prompt that follows the prompt structure may be generated based on the input in sections 502 and 504.

The suggested training questions generated by the machine learning model may be displayed in section 506. In some embodiments, the chatbot administrator may select one or more of the suggested training questions for being added to a training dataset 508. The suggested training questions may also be automatically included into the training dataset 508 after a filtering evaluation is made by the filtering system 302.

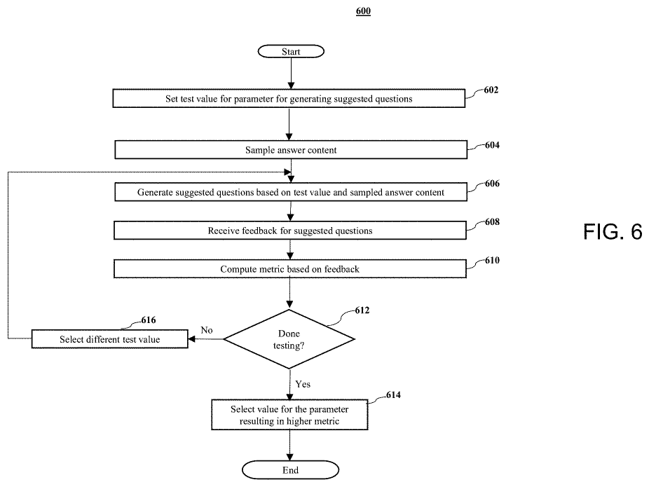

FIG. 6 is a flow diagram of a process 600 for evaluating suggested training questions according to one or more embodiments. The process starts, and in act 602, the evaluation system 304 sets a test value for a parameter or hyperparameter (collectively referenced as parameter) of the large language model used to generate suggested training questions. For example, certain test values may be tried for one of the temperature, top-k, and/or top-p hyperparameters of the large language model. In some embodiments, the parameters to be tested may relate to the prompt structure. For example, certain test wording may be used for the prompt structure to determine its effectiveness in generating relevant training questions.

In act 604, the evaluation system 304 may sample (e.g., randomly sample) the knowledge base 14 for answer content to be used for the evaluation. The answer content in the knowledge base 14 may be, for example, specific to the particular enterprise or the enterprise's vertical business, allowing the suggested training questions to also be catered to the particular enterprise and/or vertical business. A prompt for input to the language model may be generated based on the answer content. The prompt may follow, for example, a particular prompt structure and/or use particular prompt language.

In act 606, the large language model generates a suggested question based on the input prompt. In some embodiments, multiple suggested training questions are generated (e.g., serially) based on the input prompt.

In act 608, the evaluation system 304 receives feedback for the training questions generated based on the current test value. In some embodiments, the suggested training questions are displayed to the chatbot administrator, and the chatbot administrator is prompted to accept or reject the training questions. The training questions may be accepted or rejected based on the relevance of the questions to the answer content. For example, a suggested question that states, “What type of ice cream flavors do you offer?” may be accepted for an answer content that states, “The different types of ice cream flavors that we offer are chocolate, vanilla, and strawberry.” However, a training question that states, “What type of milkshake flavors do you offer” may be rejected for the same answer content.

In act 610, the evaluation system 304 computes one or more metrics based on the feedback received for the suggested training questions. In some embodiments, the computed metrics include UGR, MSAV, and/or MSAR metrics.

In act 612, the evaluation system 304 determines whether the evaluation system 304 is done testing different test values. The evaluation system 304 may be done testing when a set of different values identified for evaluation have been evaluated. If the answer is YES, the evaluation system 304 selects the value for the parameter resulting in the highest metrics (e.g., highest aggregate of the UGR, MSAV, and MSAR metrics), as the final value for the corresponding parameter of the large language model.

If, however, the evaluation system 304 is not finished testing the different test values, the evaluation system 304 selects a different test value in act 616, and the large language model that has been modified based on the new test value is invoked again for generating a suggested training question based on the input prompt.

In regards to the processes in the flow diagrams of FIGS. 4 and 6, it should be understood that the sequence of steps of the processes are not fixed, but can be modified, changed in order, performed differently, performed sequentially, concurrently, or simultaneously, or altered into any desired sequence, as recognized by a person of skill in the art.

It should be appreciated that the systems and methods for automatically generating suggestions of training questions according to one or more embodiments helps reduce the time it takes for chatbot administrators to come up with training questions. This helps expedite the building of a fast and performant chatbot system. The systems and methods according to the various embodiments help mitigate the pitfalls of traditional generative language models. For example, allowing a human (e.g., chatbot administrator) to evaluate the training suggestions may help reject biased and irrelevant training suggestions. In addition, providing an evaluation framework that uses metrics that are closely aligned with feature performance allows appropriate modifications to be made to the model to optimize performance of the language model.

In some embodiments, the system and method for automatically generating suggestions of training questions discussed above, are implemented in one or more processors. The term processor may refer to one or more processors and/or processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs).

The processor may be configured to perform the functions described herein. Each function may be performed by hardware, firmware, and/or software. For example, if the function is performed by software, the processor may be configured to execute instructions stored in a non-transitory storage medium (e.g. memory) that causes the processor to implement the function.

It will be understood that, although the terms “first”, “second”, “third”, etc., may be used herein to distinguish one element, component, or region from another. Thus, a first element, component, or region discussed herein could be termed a second element, component, or region without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of a system and method for automatically generating suggestions of training questions have been specifically described and illustrated herein, many modifications and variations will be apparent to those skilled in the art. Accordingly, it is to be understood that a system and method for automatically generating suggestions of training questions constructed according to principles of this disclosure may be embodied other than as specifically described herein. The disclosure is also defined in the following claims, and equivalents thereof.

What is claimed is:

1. A method for generating training questions comprising:
identifying a structure for generating an input;
formulating the input according to the structure;
providing the input to a first machine learning model;
receiving an output from the first machine learning model based on the input; and
training a second machine learning model based on the output.

2. The method of claim 1, wherein the structure is a prompt structure for generating a prompt, wherein the prompt identifies a task for generating the output.

3. The method of claim 2, wherein the output is a question generated based on the prompt.

4. The method of claim 3, wherein the prompt structure includes preset wording and a placeholder for entering at least an answer title or an answer content for generating the question.

5. The method of claim 1, wherein the identifying of the structure includes identifying the structure based on a predicted success of the first machine learning model in generating the output.

6. The method of claim 1, wherein the first machine learning model is a generative language model.

7. The method of claim 1 further comprising filtering the output based on a predicted characteristic of the output, wherein the training of the second machine learning model is based on the filtered output.

8. The method of claim 1, wherein the first machine learning model and the second machine learning model are different models.

9. The method of claim 1 further comprising:
selecting a hyperparameter for the first machine learning model for optimizing performance of the first machine learning model.

10. The method of claim 1 further comprising:
generating a prompt according to the structure;
providing the prompt to the first machine learning model;
receiving a first training question from the first machine learning model based on the prompt;
computing a metric for the first training question; and
altering a parameter of the first machine learning model based on the metric.

11. The method of claim 10, wherein the computing of the metric includes:
receiving feedback about the first training question; and
computing the metric based on the feedback.

12. The method of claim 11 further comprising:
including the first training question in a second prompt for generating a second training question.

13. A system for generating training questions comprising:
a processor; and
a memory, wherein the memory includes instructions that, when executed by the processor, cause the processor to:
identify a structure for generating an input;
formulate the input according to the structure;
provide the input to a first machine learning model;
receive an output from the first machine learning model based on the input; and
train a second machine learning model based on the output.

14. The system of claim 13, wherein the structure is a prompt structure for generating a prompt, wherein the prompt identifies a task for generating the output.

15. The system of claim 14, wherein the output is a question generated based on the prompt.

16. The system of claim 15, wherein the prompt structure includes preset wording and a placeholder for entering at least an answer title or an answer content for generating the question.

17. The system of claim 13, wherein the instructions that cause the processor to identify the structure include instructions that cause the processor to identify the structure based on a predicted success of the first machine learning model in generating the output.

18. The system of claim 13, wherein the first machine learning model is a generative language model.

19. The system of claim 13, wherein the instructions further cause the processor to filter the output based on a predicted characteristic of the output, wherein the instructions that cause the processor to train the second machine learning model include instructions that cause the processor to train the second machine learning model based on the filtered output.

20. The system of claim 13, wherein the first machine learning model and the second machine learning model are different models.
